(19) United States
(12) Patent Application Publication
(10) Pub. No.: US 2019/0214055 A1
(43) Pub. Date: Jul. 11, 2019

(54) METHODS AND SYSTEMS FOR CREATING SEAMLESS INTERACTIVE VIDEO CONTENT

(71) Applicant: SPLIC, INC., Palo Alto, CA (US)

(72) Inventors: Toma ALEXANDRU, Bucuresti (RO); Guillaume COHEN, Palo Alto, CA (US); Alexandre BROUAUX, Montigny le Bretonneux (FR)

(21) Appl. No.: 16/215,662

(22) Filed: Dec. 11, 2018

Related U.S. Application Data
(60) Provisional application No. 62/615,426, filed on Jan. 9, 2018.

(51) Int. Cl. G11B 27/036; G11B 27/34; G11B 27/00; H04N 9/87

(52) U.S. Cl. CPC G11B 27/036; H04N 9/8715; G11B 27/005; G11B 27/34

(57) ABSTRACT

A method and system for creating seamless interactive video content is disclosed. The method includes accessing a video content. The method also includes facilitating defining of a split point for splitting a timeline of the video content. The method further includes providing one or more interactive areas in the video content at the split point. The method includes linking the one or more interactive areas with corresponding one or more outcome video segments. The one or more outcome video segments comprise at least one of a video segment of the video content after the split point in the video content and one or more additional video segments. During playback of the video content, an input selection of an interactive area from among the one or more interactive areas enables a playback of a corresponding outcome video segment from among the one or more outcome video segments.

### TECHNICAL FIELD

Embodiments of the disclosure relate generally to interactive videos and, more particularly to, methods and systems for creating seamless interactive video content.

### BACKGROUND

Viewers of a video content experience passive involvement while viewing the video content. Interactive video content encourages active involvement of the viewer while viewing the video content. Current solutions allow a user creating interactive video content to add interactive elements to a video, such as adding links or objects in an overlay (created above the video content). However, such overlays enable a different type of interactive content.

Various technologies provide complex editing tools for creating interactive video content. However, creating interactive video content using such technologies is a complex, expensive and time-intensive process. Moreover, such technologies are used by professionals creating video content, such as, studios, advertisement agencies and cannot be accessed for use by novice users to create interactive video content.

In use, there is a number of mobile applications that provide for editing videos and enable conversion of the edited videos into linear videos. However, such mobile applications do not enable easy creation of interactive video content. Further, such mobile applications do not create seamless transitions between interactive video contents based on the choice made by a viewer.

In view of the above, there is a need for a simple yet effective tool that enables and aids novice users in creating seamless interactive video content on a mobile device with story branches and seamless transitions between story branches of the interactive video content.

### SUMMARY

Various embodiments of the present disclosure provide methods and systems for creating seamless interactive video content.

An embodiment provides a computer-implemented method for creating seamless interactive video content. The method includes accessing a video content. The method also includes facilitating defining of a split point for splitting a timeline of the video content. The method further includes providing one or more interactive areas in the video content at the split point. The method includes linking the one or more interactive areas with corresponding one or more outcome video segments. The one or more outcome video segments comprise at least one of a video segment of the video content after the split point in the video content and one or more additional video segments. During playback of the video content, an input selection of an interactive area from among the one or more interactive areas enables a playback of a corresponding outcome video segment from among the one or more outcome video segments.

Another embodiment provides a system for creating seamless interactive video content. The system includes a memory configured to store instructions. The system includes a processor configured to execute the stored instructions to cause the system to at least perform the method. The method includes accessing a video content. The method also includes facilitating defining of a split point for splitting a timeline of the video content. The method further includes providing one or more interactive areas in the video content at the split point. The method includes linking the one or more interactive areas with corresponding one or more outcome video segments. The one or more outcome video segments comprise at least one of a video segment of the video content after the split point in the video content and one or more additional video segments. During playback of the video content, an input selection of an interactive area from among the one or more interactive areas enables a playback of a corresponding outcome video segment from among the one or more outcome video segments.

Another embodiment provides a system for creating seamless interactive video content. The system includes an input module, one or more processing modules, a ping pong generation module, a sound synchronization module, a playback engine and a display module. The input module is configured to access a video content. The one or more processing modules are configured to facilitate defining a split point for splitting a timeline of the video content. Further, the one or more processing modules are configured to provide one or more interactive areas in the video content at the split point. Furthermore, the one or more processing modules are configured to link the one or more interactive areas with corresponding one or more outcome video segments. The one or more outcome video segments comprise at least one of (1) a video segment of the video content after the split point in the video content and (2) one or more additional video segments. The ping pong generation module is configured to generate an idle video loop of a threshold duration at the split point for a transition between a video playback at the split point and a video playback of an outcome video segment of the one or more outcome video segments. The idle video loop is generated based on a subset of the video content of a threshold length before the split point. The sound synchronization module is configured to perform a play back of a sound loop with the playback of the idle video loop. The idle video loop is played back in a forward and backward manner starting from the split point till a time of the input selection of the interactive area. The playback engine is configured to perform a playback of the video content. The input selection of an interactive area from among the one or more interactive areas enables a playback of a corresponding outcome video segment from among the one or more outcome video segments. The display module is configured to display the playback of an interactive video content. The interactive video content comprises an intro video content, the idle video loop, and the one or more outcome video segments. The intro video segment is a part of the video content till the split point in the timeline of the video content.

### BRIEF DESCRIPTION OF THE FIGURES

For a more complete understanding of example embodiments of the present technology, reference is now made to the following descriptions taken in connection with the accompanying drawings in which:

FIG. 1 illustrates an environment related to at least some example embodiments of the present disclosure;

FIG. 2 illustrates a block diagram representation of a system for creating and sharing interactive video content, in accordance with an example embodiment of the present disclosure;

FIG. 3 illustrates a representation of recording a video content for creating interactive video content on an application, in accordance with an example embodiment of the present disclosure;

FIG. 4A illustrates a representation of splitting the video content for creating interactive video content on an application, in accordance with an example embodiment of the present disclosure;

FIG. 4B illustrates a representation of creating a video idle loop in the video content, in accordance with an example embodiment of the present disclosure;

FIG. 4C illustrates a representation of positioning an interactive area for triggering playback of first outcome video in the interactive video content, in accordance with an example embodiment of the present disclosure;

FIG. 5A illustrates a representation of recording or importing a video content for the first outcome video, in accordance with an example embodiment of the present disclosure;

FIG. 5B illustrates a representation of using ghost frame feature for recording the first outcome video, in accordance with an example embodiment of the present disclosure;

FIG. 6A illustrates a representation of using ghost frame feature for recording the second outcome video, in accordance with an example embodiment of the present disclosure;

FIG. 6B illustrates a representation of positioning a second interactive area for triggering playback of the second outcome video in the interactive video content, in accordance with an example embodiment of the present disclosure;

FIG. 7 illustrates a representation of publishing the interactive video content created by a user, in accordance with an example embodiment of the present disclosure;

FIG. 8 illustrates a representation of linking multiple videos for creating multi-branch interactive video content, in accordance with an example embodiment of the present disclosure;

FIG. 9 illustrates a flow diagram of a method for creating interactive video content, in accordance with an example embodiment of the present disclosure;

FIG. 10 is a block diagram of a device which may be an example of a user device, in accordance with one embodiment of the present disclosure; and

FIG. 11 is a simplified block diagram of a server, in accordance with one embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various computer implemented methods and systems for creating seamless interactive video content are disclosed.

An embodiment provides an interactive video application for creating seamless interactive video content. The interactive video application and its components may rest at a server and can be downloaded and accessed on a mobile device of the user. A user records a video for creating the interactive video content via the mobile device. Alternatively, the user can import a video to the interactive video application from existing phone library or from external devices. The interactive video content may be created at the server. Alternatively, the interactive video content may be created at the mobile device of the user. The recorded or imported video may be used to create the interactive video content on the mobile device or may be sent to the server, where the interactive video content is created. The mobile device may comprise one or more input modules, a processing module, storage module, a ping pong generation module, a sound synchronization module, a playback engine, a ghost frame generation module and a display module. Alternatively, these modules may also be present in the server.

The input module is configured to receive multiple video contents from a user for making interactive video content. The processing module is configured to manage creation of the interactive video content. The processing module facilitates defining of a split point for splitting a timeline of the video content provided by the user. The video content is split into two segments, e.g., a first video segment and a second video segment based on the split point provided by the user. The split point defines the end of the first video segment, and the remainder of the original video is turned into the second video segment. The processing module can also make the whole video content as the first video segment if the user wishes to add another video as the second video segment. The user can add one or more videos as the second video segments. The processing module is configured to enable the user to position one or more interactive areas in the first video segment of the interactive video content, where each interactive area will be linked to a second video segment. The processing module is also configured to provide an option to the user to share the created interactive video content with viewers either privately or on public feed. The storage module is configured to store the interactive video content for displaying it to the viewers.

The ping pong generation module is configured to create an automatic idle video loop segment using a ping-pong effect by playing the first video segment forward and backward again and again. The idle video loop segment is placed between the first video segment and the second video segment to create a seamless effect to the viewers at the end of the first video segment. The sound synchronization module is configured to play a distinctive sound loop while the idle video loop segment is played to synchronize the sound of the first video segment and the idle video loop segment. The playback engine is configured to facilitate playing of the second video segment based on the selection made by the viewer on the interactive area of the first video segment as each interactive area is linked with a particular second video segment. The ghost frame generation module is configured to add a ghost frame feature while recording the second video segment when the user has opted for the ghost frame feature. The display module is configured to display the interactive video content i.e. first video segment, the idle video loop segment and the second video segment based on a choice of the viewer.

It must be noted that the terms ‘developer’ and ‘user’ have been used interchangeably throughout the description and these terms refer to a person creating interactive video content based on a structured narrative. The term ‘viewer’ refers to a person viewing the interactive video content and vested with powers to make choices that change story branch of the interactive video content being played back to the person.

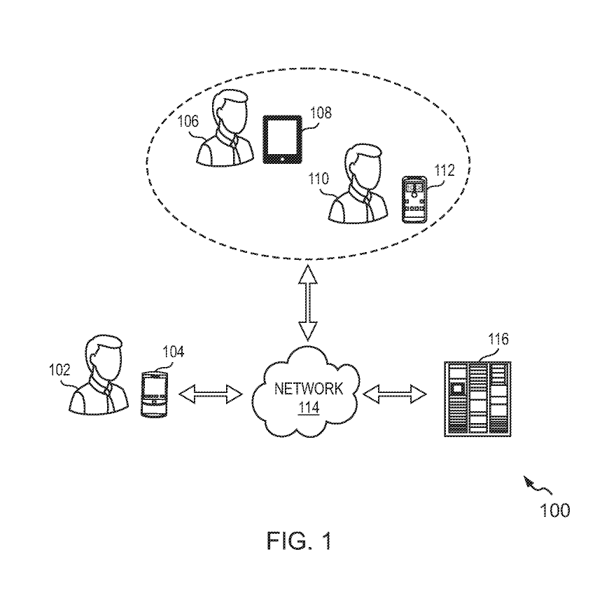

FIG. 1 shows an example representation of an environment 100 related to at least some example embodiments of the present disclosure. The environment 100 includes a user 102 who creates interactive video content and shares the interactive video content with viewers 106, 110 via a network 114 using an interactive video application available at a device 104 of the user 102. The network 114 may be centralized or decentralized network or may comprise a plurality of sub-networks that may offer a direct communication between the entities or may offer indirect communication between the entities. Typical examples of the network 114 include, but are not limited to, a wireless or wired Ethernet-based intranet, a local or wide-area network (LAN or WAN), and/or the global communications network known as the Internet, which may accommodate many different communications media and protocols.

The environment 100 further includes a server 116 where the interactive video application and its components are stored. The API and other components of the interactive video application rests on the server 116. The interactive video application can be made available at application stores such as Google play store managed by Google®, Apple app store managed by Apple®, etc. and are downloadable from the application stores to be accessed on devices such as the device 104 of the user 102, a device 108 of the viewer 106 and a device 112 of the viewer 110.

The interactive video application is a set of computer executable codes configured to perform the method disclosed herein. The set of computer executable codes may be stored in a non-transitory computer-readable medium of the device 104 of the user 102. The interactive video application is accessed by the user 102 on the device 104 to create interactive video content and share the interactive video content with the devices 108 and 112 of the viewers 106 and 110 respectively.

Alternatively, the set of computer executable codes may be stored in a non-transitory computer-readable medium of the server 116, such that the workflows and operations of creating interactive video content by the interactive video application are performed at the server 116. In such an instance, the device 104 of the user 102 is configured to just send video input to the server 116.

The user 102 and the viewers 106, 110 may have one or more devices. For example, the user 102 has the device 104, the viewer 106 has the device 108 and the viewer 110 has the device 112. Examples of the devices 104, 108 and 112 may include, but are not limited to mobile phones, tablets, notebooks, laptops, desktops and personal digital assistants (PDAs), among others. The devices 104, 108, 112 are equipped with subscriber identity module (SIM) or Removable User Identity Module (R-UIM) to enable cellular communication. The cellular communication is enabled by cellular-based communication protocols such as AMPS, CDMA, TDMA, GSM (Global System for Mobile communications), iDEN, GPRS, EDGE (Enhanced Data rates for GSM Evolution), UMTS (Universal Mobile Telecommunications System), WCDMA and their variants, among others.

The user 102 can access the interactive video application (not shown in FIG. 1) on the device 104 for creating seamless interactive video content on the device 104 and for sharing the interactive video content with the viewers 106 and 110. An instance of the interactive video application is installed at the devices 104, 108, 112 using application stores associated with any of Apple iOS™, Android™ OS, Google Chrome OS, Symbian OS®, Windows Mobile® OS, Windows Phone, BlackBerry OS, Embedded Linux, WebOS, Palm OS® or Palm Web OS™, and the like.

The server 116 is configured to host and manage the interactive video application and communicate with user devices, such as the device 104 to publish the interactive video content created by the user 102 for viewing by the viewers 106, 110. The interactive video application comprises a simple user interface for editing and creating the interactive video content. Further, the interactive video application provides user interfaces at the devices 108 and 112 associated with the viewers 106 and 110, respectively, that enables viewing of the interactive video content by the viewers 106 and 110. The server 116 can be centralized or decentralized and is distributed across multiple locations.

Interactive video content, within the scope of this disclosure implies structured narrative videos that branch out depending on choices (selection input) provided by the viewer 110 such that consequences/outcome depend on choices made by the viewer 110. The interactive video application may provide options for viewers (such as the viewers 106, 110) to change a segment/portion, for example, plot of a story, of the interactive video content at any point when a segment/portion of the interactive video content has finished playing. A structured narrative video can have branches (or alternative scenes), each having a different sound or different picture or both and displaying different sentiments. During playback of the structured narrative video, one of the alternative scenes, is played back to one of the viewers 106, 110 based on a choice made by the viewers 106, 110. For example, an interactive video content comprises a story with two alternative scenes based on different point of views. The viewers 106, 110 have options to make a choice at a point in the timeline of the ongoing video, such that one of the alternative scenes are played back to the viewers 106, 110 based on the choice made by the viewer 110. It must be noted that each of the viewers 106, 110 can make choices independently and consequence of their choice is displayed as a seamless interactive video in their respective devices 108, 112.

In an embodiment, the user 102 records a video for creating the interactive video content via the device 104. Alternatively, the user 102 can import a video to the interactive video application from existing phone library or from external devices. The user 102 can then choose a split point/juncture on a timeline of the interactive video content (recorded or imported) to split the video content into at least two segments, e.g., the first video segment (also referred to herein as ‘intro video segment’) and the second video segment (also referred to herein as ‘outcome video segment’). The video content is segmented at a timeline of the video segment to provide choices to the viewers 106, 110. In at least one example embodiment, the split point is a sliding handle that can be moved in ether directions (left or right) on the timeline of the video content and placed at a point (referred to as ‘the split point’) for segmenting the video content into an intro video content and a video segment (also referred to herein as ‘outcome video segment’). The split point defines the end of the intro video content and the video segment after the split point constitutes an outcome video segment.

In an embodiment, the choice is provided by means of one or more interactive areas on the intro video segment. Examples of the interactive areas may be any of tilt, slide, sound detection, touch input on colours, images, representations, text and the like. In an embodiment, each of the interactive area is linked with an outcome video segment. When the viewer 110 provides a selection input on an interactive area, the outcome video segment corresponding to the interactive area is played back to the viewer 110.

Further, the interactive video application generates an idle video loop of a threshold duration, and it is played back when the viewer reaches the split point of the video content. In an embodiment, the threshold duration may be adaptable and the user 102 is provided with an option of changing the threshold duration. For example, the user may define the threshold duration as 5 seconds maximum before which the viewer must provide the selection input on at least one interactive area. The idle video loop is generated based on a subset of the video content for the threshold length before the split point. The idle video loop is played back in a forward and backward manner (e.g., a ping pong effect) starting from the split point till a time of receiving the input selection on any one of the interactive area creating a seamless effect to the viewers 106, 110 at the end of the intro video segment.

In an embodiment, the interactive video application enables the user 102 to position the one or more interactive areas in the intro video segment of the interactive video content. In an embodiment, selection (tapping) of one of the one or more interactive areas by the viewer (e.g., the viewer 110) triggers the playback of a corresponding outcome video segment in continuation of the intro video segment. In this example representation, the outcome video segment is a continuation of the intro video segment and hence the interactive video application ensures that there is a seamless transition while playing back the outcome video segment of the interactive video content when the viewer 110 taps on the interactive area.

In another embodiment, the interactive video application provides an option for the user 102 to add one or more additional video segments as outcome video segments for the intro video segment. Each of the one or more outcome video segments may present different outcomes and portray different themes and sentiments of the interactive video content. The different outcomes depict different story branches that are consequences of choices made by the viewers 106, 110.

The outcome video segment can either be recorded via the device 104 or imported to the interactive video application from the device library (or external devices). In an embodiment, the interactive video application provisions for using a ghost frame feature while recording the outcome video segment. The ghost frame is a translucent frame taken from an image frame of the intro video segment, such that the user 102 can alter and adjust position of his/her camera module in the device 104 to initiate recording of an outcome video segment to be as similar as possible to the intro video segment. For example, one or more objects in the ghost frame are aligned to match one or more objects viewed via a camera module on the display screen of the device 104. In another embodiment, the outcome video segment can be imported from external sources, such as YouTube®, Google® videos, etc.

In at least one example embodiment, the outcome video segment can provision one or more additional interactive areas on each of the one or more outcome video segments for facilitating branching of the interactive video content. The one or more additional interactive areas are linked to corresponding one or more additional outcome video segments. In an example, the user 102 splits a video content A at a timeline ‘t1’ to form intro video segment A1 and an outcome video segment A2. Further, the user 102 provides one or more additional video segments A3, A4 as an option for outcome video segment A2. The outcome video segments A2, A3 and A4 are provided with interactive areas i1, i2, i3, respectively. The user 102 further branches out the interactive video content by providing additional interactive areas for each of the outcome video segments A2, A3, A4. Each of the additional interactive areas is linked with an additional outcome video segment that may be recorded or imported to the interactive video application. For example, outcome video segment A3 is associated with interactive areas r1, r2, r3 that are linked to additional outcome video segments B1, B2, B3.

In an embodiment, the user 102 has options to preview the interactive video content created with one or more outcome video segments and publish the created interactive video content. The user 102 can share the interactive video content with the viewers 106, 110 either privately or on public feed via the interactive video application. Additionally, the interactive video application allows the user 102 to link multiple video contents by compiling an outcome video segment of an interactive video content as the intro video segment for another outcome video segment. It must be noted that playback of the outcome video segment to the viewers 106, 110 is not restricted to tapping the second interactive area. The interactive video application supports other means of interaction (triggering playback of the outcome video segment) such as tilt, slide, sound detection and the like to trigger playback of a different outcome video segment based on the interactive (trigger) action performed.

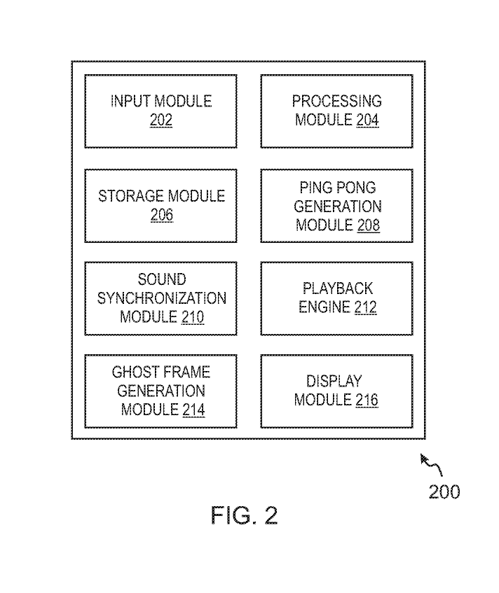

Various example embodiments illustrate the interactive video application for facilitating creation and playback of interactive video content. The interactive video application enables one or more user interfaces that facilitate creation and sharing of interactive video content. The user interfaces will be described with reference to FIGS. 2 to 10. It is to be noted that throughout the description, playback of the seamless interactive video content to the viewers 106, 110 at the devices 108, 112 is explained for describing the creation of the interactive video content.

Referring now to FIG. 2, a block diagram representation of a system 200 displaying various modules for creating and sharing interactive video content is illustrated, in accordance with an example embodiment. The system (hereinafter interchangeably referred to as ‘interactive video creation system 200’) may be a part of the device 104 of the user 102. Additionally or alternatively, the interactive video creation system 200 may be a part of the server 116. Similarly, the interactive video creation system 200 or modules of the interactive video creation system 200 may be provisioned in the devices 108 and 112 of the viewers 106 and 110 respectively.

The interactive video creation system 200 of the device 104 provides a provision to the user 102 for creating interactive video content by the user 102. The interactive video creation system 200 facilitates viewing of the interactive video content created by a developer, for example, the user 102 by the viewers 106, 110 on their respective devices 108 and 112. It should be noted that the viewers 106, 110 can also create the interactive video content using the interactive video creation system 200 and the user 102 can also view the interactive video content generated by the viewers 106, 110. The interactive video creation system 200 comprises an input module 202, a processing module 204, a storage module 206, a ping pong generation module 208, a sound synchronization module 210, a playback engine 212, a ghost frame generation module 214 and a display module 216. It shall be noted that the interactive video creation system 200 or the modules (202, 204, 206, 208, 210, 212, 214 and 216) are in operative communication with a processor of the device 104.

The input module 202 is configured to access video content from the one or more devices present in the environment 100. The input module 202 may include at least one input interface. Examples of the input interface may include, but are not limited to, a keyboard, a mouse, a joystick, a keypad, a touch screen, soft keys, a microphone, a camera module and the like. In an embodiment, the input module 202 is configured to record a video using the camera module or import video content from a memory of the system 200 or external devices for creating interactive video content.

It is noted that although the interactive video creation system 200 is depicted to include only one processing module 204, the interactive video creation system 200 may include more number of processing modules therein. In an embodiment, the storage module 206 is capable of storing machine executable instructions. Further, the processing module 204 is capable of executing the machine executable instructions. In an embodiment, the processing module 204 may be embodied as a multi-core processor, a single core processor, or a combination of one or more multi-core processors and one or more single core processors. For example, the processing module 204 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processing module 204 may be configured to execute hard-coded functionality. In an embodiment, the processing module 204 is embodied as an executor of software instructions, wherein the instructions may specifically configure the processing module 204 to perform the algorithms and/or operations described herein when the instructions are executed.

The storage module 206 may be embodied as one or more volatile memory devices, one or more non-volatile memory devices, and/or a combination of one or more volatile memory devices and non-volatile memory devices. For example, the storage module 206 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.).

In an embodiment, the processing module 204 is configured to facilitate defining of a split point on the video content for splitting a timeline of the video content provided by the user 102. The processing module 204 splits the video content into two segments, an intro video segment and an outcome video segment based on the split point provided by the user 102. The split point defines the end of the intro video segment, and the video segment after the split point constitutes the outcome video segment. The processing module 204 can also make the whole video content as the intro video segment if the user 102 wishes to add another video as the outcome video segment. The user 102 can add one or more outcome video segments either by capturing the outcome video segments using the input module 202 or importing outcome video segments from external systems. In at least one embodiment, the processing module 204 is configured to enable the user 102 to position one or more interactive areas in the intro video segment of the interactive video content, wherein each interactive area is linked to a corresponding outcome video segment. The processing module 204 is also configured to provide an option to the user 102 to share the created interactive video content with the viewers 106, 110 either privately or on public feed.

In an embodiment, the storage module 206 is configured to store the interactive video content if the user 102 intends to save the interactive video content. The storage module 206 is also configured to link and store the outcome video segments associated with each of the interactive areas in the intro video segment.

The ping pong generation module 208 is configured to create an automatic idle video loop segment like a ping-pong effect by playing the intro video segment forward and backward again and again. The idle video loop is played back in a forward and backward manner starting from the split point till a time of receiving an input selection of the interactive area. In an embodiment, the idle video loop is played back for a threshold duration at the split point for a transition between a video playback at the split point and a video playback of an outcome video segment. The idle video loop is generated based on a subset of the video content of a threshold length before the split point. Accordingly, the ping pong generation module 208 reverses the video content, and generates a idle video loop segment by taking some parts of the intro video segment from video content and reversed video content and then places the idle video loop segment between the intro video segment and the outcome video segment. The ping pong generation module 208 is configured to create a seamless effect to the viewers 106, 110 at the end of the intro video segment.

The sound synchronization module 210 is configured to perform a automatic sound loop synchronization. The sound synchronization module 210 may play a distinctive sound loop whose tempo is adjusted to match the frequency of the idle video loop segment. The sound synchronization module 210 may play the distinctive sound loop while the idle video loop segment is played to synchronize the sound of the intro video segment and the idle video loop segment.

The playback engine 212 is in communication with the input module 202 and the display module 216. In an embodiment, the playback engine 212 is configured to facilitate play back of an interactive video content based on a selection input received from a viewer (e.g., the viewers 106, 110) on at least one interactive area of the intro video segment as each interactive area is linked with a particular outcome video segment. The viewer performs an interactive action, such as tap on the interactive area of the intro video segment for selecting playback of a specific outcome video segment. In another embodiment, the playback engine 212 is configured to facilitate playing of multiple outcome videos in a queue in case the viewer does not provide the selection input on the interactive area of the intro video segment. The playback engine 212 comprises multiple sub-video players. Each sub-video player is dynamically assigned an upcoming video segment. The sub-video player intelligently pre-buffers and preloads the upcoming video (outcome video segment/additional outcome video segment) so that playback of the outcome video segment starts instantly after the viewer performs the interactive action (the selection input) on the interactive area of the intro video segment, with a slight crossfading effect to smooth out the transitions. In yet another embodiment, the playback engine 212 is configured to ensure that there is a seamless transition while playing the outcome video segment of the interactive video content when the viewer performs the interactive action on the interactive area.

The ghost frame generation module 214 is in communication with the input module 202. The ghost frame generation module 214 is configured to generate a ghost frames while recording the outcome video segment/additional outcome video segment for aligning one or more objects in the video content before the split point along with one or more objects viewed via the camera module of the input module 202. The ghost frame is a translucent frame taken from at least one image frame from the intro video segment, such that the user 102 can alter and adjust position of his/her camera module in the device 104 to match the outcome video segment to be as similar as possible to the intro video segment while recording the outcome video segment.

The display module 216 is configured to display and perform playback the interactive video content in one or more devices, such as the devices 104, 108, 112 depicted in the environment 100. The display module 216 includes an output interface. Examples of the output interface may include, but are not limited to, a display such as a light emitting diode display, a thin-film transistor (TFT) display, a liquid crystal display, an active-matrix organic light-emitting diode (AMOLED) display, a microphone, and the like. In an embodiment, the display module 216 is configured to display interactive video contents to the viewers. The display module 216 is configured to display the intro video segment, the idle video loop segment and the outcome video segment based on the interactive area selected by the viewer.

In an example scenario, the video content corresponds to a story depicting how a random act of kindness by a stranger fills his life with goodness. In an embodiment, a user may split the video content at a split point into an intro video segment depicting a random stranger and a first outcome video segment depicting kindness of the stranger being repaid with goodness. The user adds outcome video segments (e.g., a second outcome video segment and a third outcome video segment) depicting the kindness shown by the stranger transforming many people, and the third outcome video segment depicts the kind stranger being repaid with evil, respectively. The outcome video segments are linked with a respective interactive area on the intro video segment. For example, the first outcome video segments is represented by a first colour pattern, the second outcome video segments is represented by a second colour pattern and the third outcome video segments is represented by a third colour pattern. When the video content is played back to a viewer, for example, the viewer 110, the first colour pattern, the second colour pattern and the third colour pattern are displayed to the viewer on an idle video loop segment at the split point. If the viewer selects second colour pattern, the interactive video content will depict the random stranger's act of kindness transforming many people.

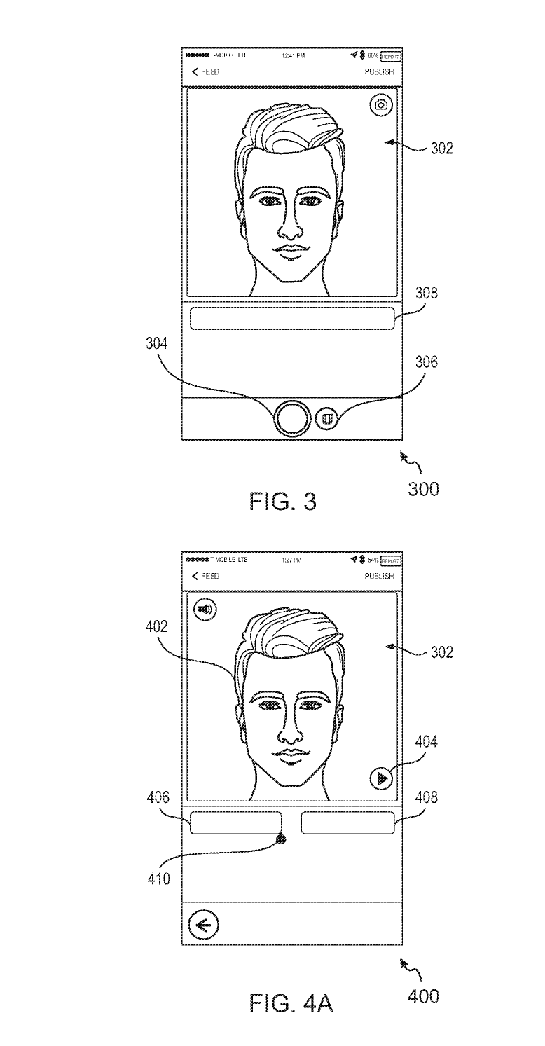

Referring now to FIG. 3, a representation 300 of recording a video by a user (e.g., the user 102) using a device (e.g., the device 104) for creating interactive video content is illustrated, in accordance with an example embodiment. The one or more UIs displayed by the interactive video application for creating and sharing the interactive video content is described with reference to FIGS. 3-7.

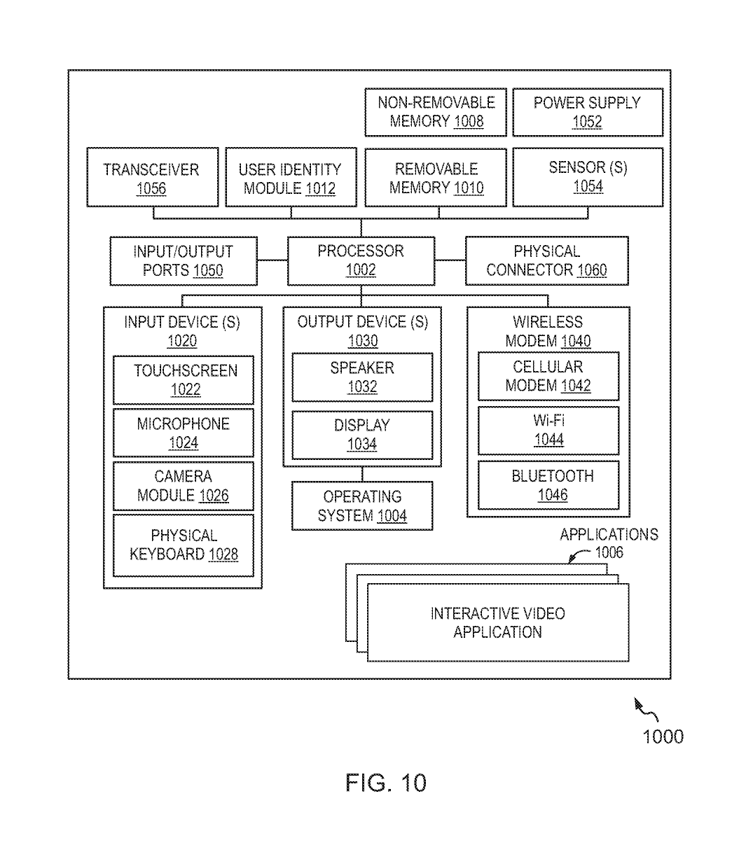

A user can access the interactive video application to create interactive video content via a user device such as, the device 104. The interactive video application enables recording a video using image capturing module (see, camera module 1026 shown in FIG. 10) in the user device for creating the interactive video content. The interactive video application includes a video display 302 that is configured to display an image frame viewed by the image capturing module of the user device.

The image frames (video) displayed at the video display 302 are captured by the user by clicking on a record button 304 located below the video display 302. The recording of the image frames can be terminated by clicking on a stop button (not shown) that appears in place of the record button 304 while recording the video. Alternatively, the user can import video content from a device library or an external device by clicking on an import button 306 provided next to the record button 304. For example, the user can select video content from a library comprising a plurality of video contents and import it to the interactive video application using the import button 306 for creating interactive video content. The interactive video application includes a timeline 308 that shows progress in recording of the video on the user device.

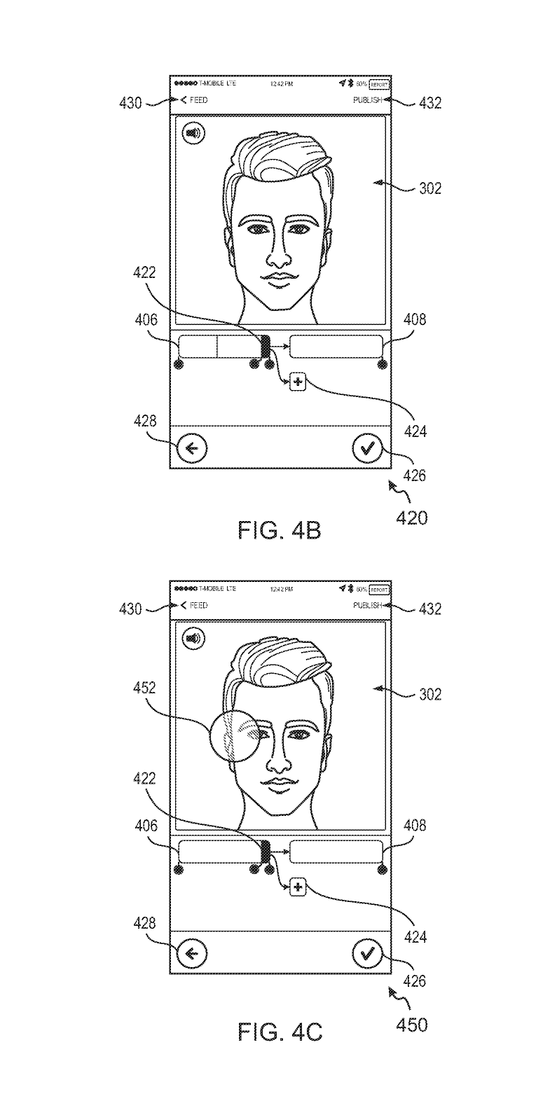

Referring now to FIG. 4A, a representation 400 of splitting the video content for creating interactive video content using the interactive video application, is illustrated in accordance with an example embodiment. The video content includes a video either recorded using recording options provided by the interactive video application or a video imported from device library (or external devices).

The video display 302 displays an image frame 402 of the video content. The video display 302 includes a play button 404 overlaid on the image frame 402 of the video content. The user can playback the video content by clicking on the play button 404. The timeline 308 as seen in FIG. 3 includes a draggable handle 410 that can be used by the user 102 to split the video content into two video segments as, an intro video segment 406 and an outcome video segment 408. The user can playback the video content using the play button 404 and select a split point by moving the draggable handle 410 on the timeline 308 to split the video content. The split point is created to segment the video content, such that the user can create a story branch or a structured narrative of interactive video content that changes with choices made by a viewer, such as, the viewer 106 playing back the interactive video content.

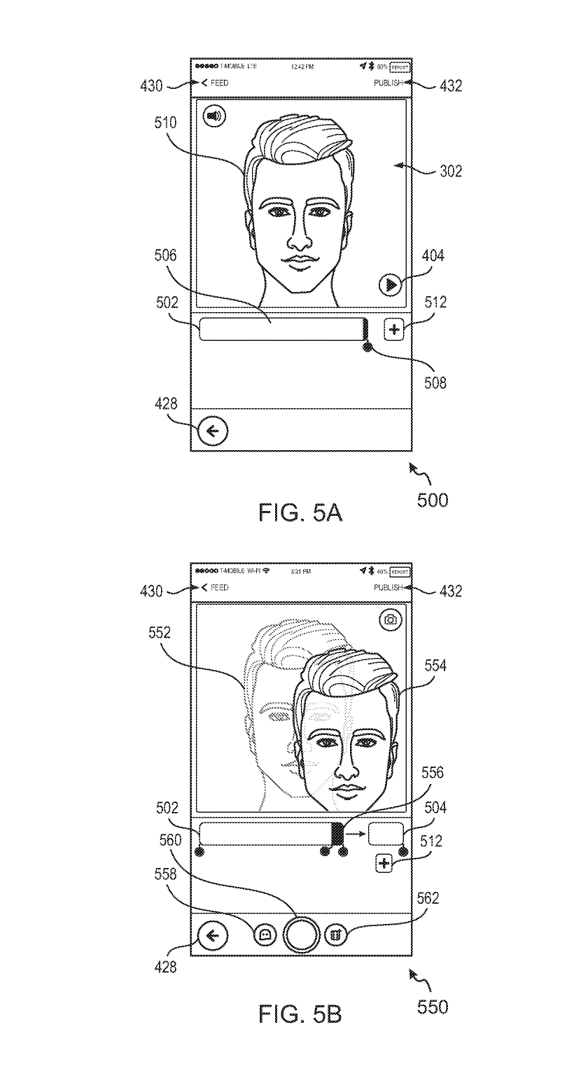

In an example embodiment, a user (e.g., the user 102) can split a recorded or an imported video content/video into two segments, the intro video segment 406 and the outcome video segment 408. In this scenario, the choice provided to the viewers 106, 110 for the outcome video segment may be limited to one. An interactive video content created in this manner includes the intro video segment, an idle loop segment (described with reference to FIG. 4B) and the outcome video segment. In another example embodiment, the user may add a plurality of recorded or imported video segments as the outcome video segments. In such a scenario, as many choices as the number of video segments added may be provided to the viewers 106, 110. Adding recorded or imported video to create the outcome video segment is explained in detail with reference to FIGS. 5A and 5B.

For instance, the user may create a short movie as interactive video content comprising a plot (the intro video segment 406) and two different climax scenarios (the outcome video segment 408). The user creates the split point on the timeline 308 by positioning the draggable handle 410 at a split point where the plot (the intro video segment 406) ends and the climax scenario begins. The viewer (e.g., the viewer 110) while playing back the interactive video content is provided with choices (one or more interactive areas) for selecting an outcome video segment. The viewer is prompted to make a choice based on which climax scenario (of the two different climax scenarios) is played back along with the intro video segment 406.

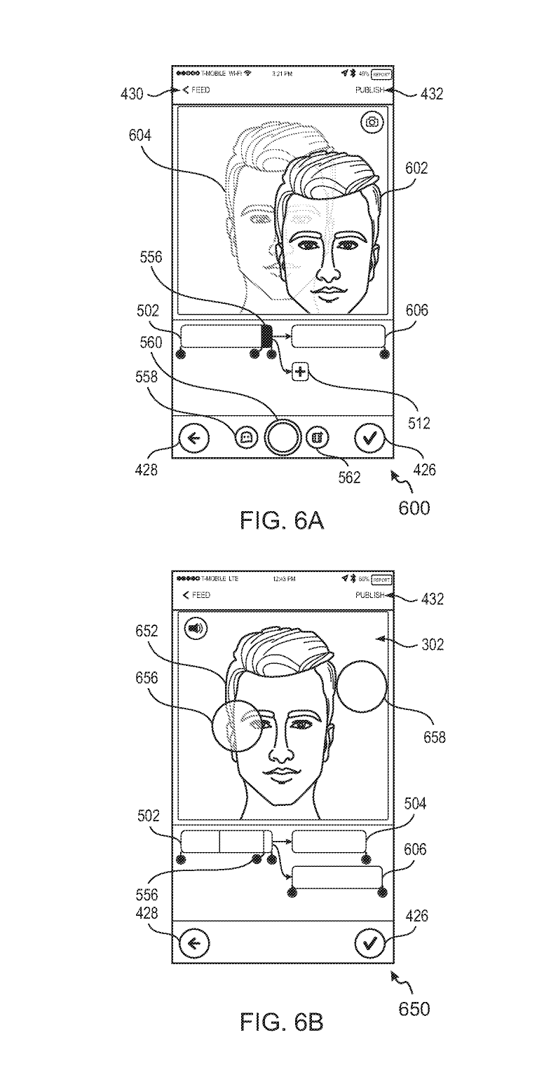

Referring now to FIG. 4B, a representation 420 of the interactive video application creating an idle video loop segment 422 in the video is illustrated in accordance with an example embodiment. When the user splits the video content into the intro video segment 406 and the outcome video segment 408, the interactive video application automatically creates an adjustable idle video loop segment 422 of threshold duration at the end of the intro video segment 406 that viewers can see while the interactive video application is waiting for them to provide a selection input on an interactive area (shown in FIG. 4C represented by 452 and FIG. 6B represented by 656 and 658). The threshold duration may be adaptable based on a user input.

In an embodiment, the idle video loop segment 422 is created using a ping-pong effect by playing the intro video segment 406 forward and backward thereby creating a seamless effect which viewer can view while the interactive video application waits for the selection input (tap) from the viewer on at least one interactive area. It shall be understood that the idle video loop segment 422 is, in practical scenarios, created when the user presses “+” button (see 512, in FIGS. 5A and 5B) to add a video segment as an outcome video. Tapping on the interactive area to playback the outcome video segment 408 to the viewer is explained in detail with reference to FIG. 4C.

In an embodiment, the intro video segment 406 is reversed and the idle video loop segment 422 is generated by taking at least some part (or segment) of the intro video segment 406 (forward video content) and the reversed video content corresponding to the intro video segment 406. The idle video loop segment 422 is played forward and backward indefinitely to create a seamless loop, until the viewer taps the interactive area. The idle video loop segment 422 is created such that the user can change boundaries of the idle video loop segment 422 and directly visualize the resulting ping pong without having to wait for re-computation of that ping pong. The interactive video application further provisions for an automatic sound loop synchronization such that while the idle loop is playing, a distinctive sound loop is played and its tempo is adjusted to match the frequency of the video content.

The interactive video application also includes an add outcome button 424 displayed below the outcome video segment 408. The add outcome button 424 is explained in detail with reference to FIG. 4C. The interactive video application includes a save button 426, a back button 428, a feed button 430 and a publish button 432. The user can click on the save button 426 to save the interactive video content that has been created. Clicking on the back button 428 navigates the user to prior operation that was being performed. In this example, the user will be navigated and displayed with video content displayed on the video display 302 prior to splitting the video content. The user can view his/her feed by clicking on the feed button 430. The feed displays interactive video content created and shared by other users along with interactive video content shared by the user in past. The user can click on the publish button 432 to share the interactive video content created using a device (e.g., the device 104) by the user with one or more viewers (or peers), such as, the viewers 106, 110 in his/her feed (on the interactive video application) or social network. Publishing interactive video content is further explained in detail with reference to FIG. 6.

Referring now to FIG. 4C, a representation 450 of an interactive area 452 for triggering playback of the outcome video segment 408 in the interactive video content is illustrated in accordance with an example embodiment. When the user splits the interactive video content to the intro video segment 406 and the outcome video segment 408, the interactive video application automatically creates the idle video loop segment 422 and provisions for the user to position the interactive area 452 corresponding to the outcome video segment 408 on the image frame 402 displayed in the video display 302. The interactive area 452 is draggable and can be positioned anywhere on the image frame 402. The interactive area 452 is represented as a dot using a first color which can be dragged by the user to choose a part of the video segment to make it interactive.

In an embodiment, during the playback when a viewer (e.g., the viewer 106) viewing the interactive video content reaches the split point, the viewer is presented with the interactive area 452. The tap of the user on the interactive area 452 will trigger the interactive video application to playback the outcome video segment 408. In this example representation, the interactive video application ensures that the transition from the intro video segment 406 to the outcome video segment 408 is seamless since the outcome video segment 408 is a continuation of the intro video segment 406 (shown by the timeline 308 corresponding to the video content in FIG. 3A). It must be noted that the interactive video application triggering playback of the outcome video segment, such as, the outcome video segment 408 is not restricted to tapping on the interactive area 452 but the interactive video application also supports other means of interaction such as, tilt, slide and the like to trigger a different video outcome based on the interactive action performed.

In an embodiment, when the user splits the video segment to generate the intro video segment 406 and the outcome video segment 408 (first outcome video segment), the interactive video application provisions the add outcome button 424 (below the timeline 308) for adding another outcome video segment 408 (e.g., second video segment). The user can use the add outcome button 424 to add multiple outcome segments. Each time the user records/imports an outcome video segment, the interactive video application provisions an option to add another outcome video segment using the add outcome button 424. The multiple outcome video segments (added using the add outcome button 424) form different story branches for the intro video segment 406.

In an embodiment, the interactive video application provisions for presenting/displaying more than one interactive areas, where each interactive area corresponds to the outcome video segment 408. The user can assign an interactive area in the image frame 402 associated with the intro video segment 406. Tapping on an interactive area triggers playback of corresponding outcome video segment.

Referring now to FIG. 5A, a representation 500 of recording or importing a video content for creating an outcome video segment (the first outcome video segment 504 shown in FIG. 5B) is illustrated in accordance with an example embodiment. In an embodiment, the user creates an outcome video segment (the outcome video segment 504) for an intro video segment 502 rather than splitting the interactive video content to generate the intro video segment and the outcome video segment (as shown in FIG. 4A). In this example representation, the outcome video segment is either recorded via the interactive video application or imported to the interactive video application. In another example embodiment, the outcome video segment can also be created by importing videos from external sources such as YouTube®, Google® videos, etc. The interactive video application provisions for enabling a user (such as the user 102) to browse videos from external sources while accessing the interactive video application. The user chooses to use the entire video content as the intro video segment 502 and hence places the split point at end of the video segment using a draggable handle 508 on a timeline 506. It shall be noted that the user 102 may be provided with options to edit the intro video segment by trimming it.

In this non-limiting example, an image frame 510 is displayed on the video display 302 of the interactive video application along with the play button 404. In an embodiment, an add outcome button 512 is displayed beside the timeline 506. The user can click on the add outcome button 512 to create the outcome (the first outcome video segment 504 shown in FIG. 5B). The outcome (the first outcome video segment 504) is created by either recording video content using the interactive video application or importing video content from library or external device, such as, memory cards. Recording video content to create the first outcome video segment 504 is further explained with reference to FIG. 5B.

Referring now to FIG. 5B, a representation 550 of using ghost frame feature for recording the first outcome video segment 504 is illustrated in accordance with an example embodiment. The ghost frame is a translucent image frame 552. The translucent image frame 552 may correspond to at least one frame of the intro video segment 502 or edge information of objects computed from one or more image frames of the intro video segment 502 may be used to generate the translucent image frame 552. The ghost frame i.e. the translucent image frame 552 is an image frame from the intro video segment 502 that is used as a reference for recording image frames corresponding the first outcome video segment 504 by the user such that, during playback, the first outcome video segment 504 has a seamless transition from the intro video segment 502 and appears as a continuity of the intro video segment 502.

In an embodiment, the ghost frame (the translucent image frame 552) is overlaid on top of an image frame 554 viewed on the video display 302 while recording video (the first outcome video segment 504) using camera module in user device, such as the device 104. The ghost frame feature allows the user to adjust and/or alter position of camera module in the user device to capture the outcome video segment 504 similar to the intro video segment 502 such that there is seamless transition and continuity in the interactive video content created by merging the intro video segment 502 and the first outcome video segment 504.

The timeline 506 (shown in FIG. 5A) includes an idle video loop segment 556 at end of the intro video segment 502. The idle video loop segment 556 is automatically created by the interactive video application using a ping-pong effect in which at least a part of the intro video segment 502 is played back along with at least a part of reversed intro video segment creating a seamless effect.

The interactive video application includes a ghost frame button 558, a record button 560 and an import video button 562. The user can enable/disable overlay of the ghost frame (the translucent image frame 552) by clicking on the ghost frame button 558. When the user clicks on the ghost frame button 558, the translucent image frame 552 appears on the image frame 554 viewed via camera module of the user device. The user alters position of camera module and/or user device such that the image frame 554 appears similar (overlays) to the translucent image frame 552. The record button 560 can be clicked by the user to initiate recording of video segment corresponding to the outcome video segment 504. The import video button 562 is similar to the import button 306 shown and explained with reference to FIG. 3.

Referring now to FIG. 6A, a representation 600 of using ghost frame feature for recording a second outcome video segment 606 is illustrated in accordance with an example embodiment. The user can add multiple outcome segments by clicking on the add outcome button 512. The add outcome button 512 is same as the add outcome button 424 shown and explained with reference to FIG. 4C.

The user can record or import video segment for the second outcome video segment 606. In this example representation, the user intends to record a video segment for the second outcome video segment 606. The user records the second outcome video segment 606 by clicking on the record button 560. In an embodiment, the user can enable a ghost frame 604 by clicking on the ghost frame button 558. For example, an image frame 602 displayed on the video display 302 is the image frame viewed via camera module in the user device (e.g., the device 104) prior to initiation of recording the second outcome video segment 606. The image frame 602 if used as such to initiate recording of image frames of the outcome video segment, the outcome video segment will appear as a continuation of the intro video segment 502. The ghost frame 604 is therefore overlaid as a reference frame on the image frame 602 viewed via the camera module of the user device. The user adjusts position of camera module and/or user device such that the image frame 602 viewed via the camera module is aligned with the ghost frame 604. The ghost frame feature is further explained in detail with reference to FIG. 5B.

The interactive video application provides options to save the interactive video content comprising the intro video segment 502, the first outcome video segment 504 and the second outcome video segment 606 using the save button 426.

Referring now to FIG. 6B, a representation 650 of a first interactive area 656 and a second interactive area 658 for triggering playback of the first outcome video segment 504 and the second outcome video segment 606 in the interactive video content, is illustrated in accordance with an example embodiment.

In this example representation, the second outcome video segment 606 has been recorded using the ghost frame 604 shown and explained with reference to FIG. 6B. In an example embodiment, the first interactive area 656 corresponding to the first outcome video segment 504 has been positioned on an image frame 652 associated with the interactive video content. When the user completes recording the second outcome video segment 606, the user is prompted to position the second interactive area 658 on the image frame 652 on the interactive video content. The image frame 652 may correspond to a last frame of the intro video segment 502. The first interactive area 656 is represented by a dot using a first colour. The second interactive area 658 is represented by a dot using a second colour.

During playback, tapping on the second interactive area 658 triggers playback of the second outcome video segment 606 to a viewer (e.g., the viewer 110). For instance, during playback, the viewer is presented with the intro video segment 502 initially. The viewer is presented with a choice/option to choose either the first outcome video segment 504 or the second outcome video segment 606. The options are presented as the first interactive area 656 and the second interactive area 658 while the idle video loop segment 556 is played back to the viewer. If the viewer taps on the first interactive area 656, the first outcome video segment 504 is played back as a continuation of the intro video segment 502 to the viewer. Alternatively, a tap on the second interactive area 658 prompts the interactive video application to play back the second outcome video segment 606 to the viewer as a continuation to the intro video segment 502.

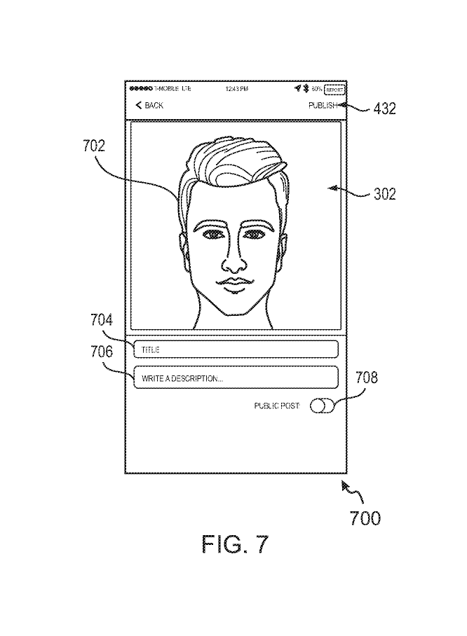

Referring now to FIG. 7, a representation of publishing the interactive video content created by a user is illustrated in accordance with an example embodiment. When the user clicks on the save button 426 (shown in FIG. 4B) in the interactive video application, a preview page 700 is presented to the user.

The preview page 700 of the interactive video application displays an image frame 702 corresponding to the interactive video content to the user. The page 700 includes a title section 704, a description section 706 and a public post toggle 708. The user can provide a title for the interactive video content created by him/her in the title section 704. The user can provide a short description about the interactive video content in the description section 706. The public post toggle 708 provides option for the user to make the interactive video content a public post that can be viewed by everyone accessing the interactive video application on the feed or the user can restrict sharing of the interactive video content to peers (or social circle). The page 700 includes the publish button 432 on top part of the page 700. The user can publish or share the interactive video content by clicking on the publish button 432.

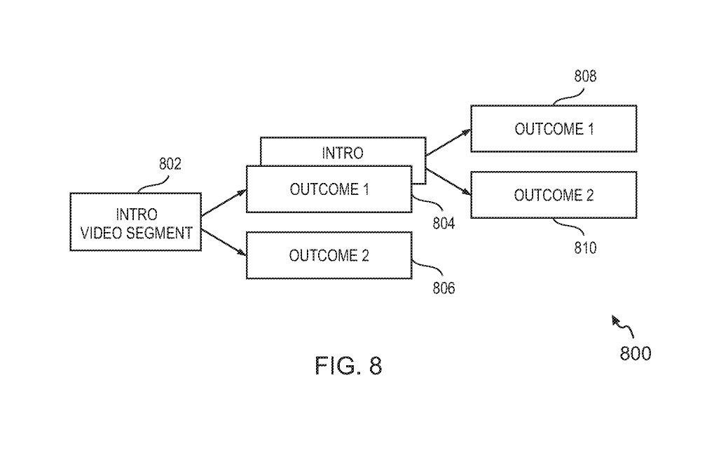

Referring now to FIG. 8, a representation of linking multiple video contents for creating a multi-branch interactive video content 800 is illustrated, in accordance with an example embodiment. The multi-branch interactive video content 800 is created by making an outcome video segment as intro video segment for another video content that is created as outcome video segment. Such method of linking multiple video contents enables users to create multi-branch video stories by linking multiple video segments together.

An intro video segment 802 forms base for the multi-branch interactive video content 800. As shown in FIG. 8, the intro video segment 802 is linked to an outcome video segment 804 and an outcome video segment 806. Each of the outcome video segments 804 and 806 may be linked with an interactive area, for example, colours A1, A2 respectively at the split point defined on the intro video segment 802. In an example, the interactive video content 800 branches out to the outcome video segment 806 if the viewer selects the colour A2 displayed on the intro video segment 802 at the split point.

In an embodiment, the intro video segment 802 is either created by splitting a video content at a timeline ‘t1’ such as to form the intro video segment 802 and the outcome video segment 804. Alternatively, the video content is not split and entire video content is used as the intro video content 802. The outcome video segment 804 and the outcome video segment 806 are either recorded using the interactive video application installed in a user device therein or imported from an external system or device library of the user device.

In an embodiment, the outcome video segment 804 is configured to be an intro video segment for outcome video segments 808 and 810. This includes defining one or more additional interactive areas on each of the one or more outcome video segments such as the segment 804 and the segment 806. The one or more additional interactive areas are linked to corresponding one or more additional outcome video segments. For instance, the additional interactive areas are defined as characters Jane, John for outcome segment 804 and James, Sara for outcome segment 806. In an example, if the viewer has provided a selection input on colour A1, the outcome video segment 804 is played back till a split point ‘t2’ is detected on timeline of the outcome video segment 804. In an example scenario, upon detecting the split point ‘t2’ at the timeline of the outcome video segment, the processor is prompted to provide additional interactive area (Jane, John) corresponding to the outcome video segment 804. The viewer can provide the selection input on any one of the additional interactive area (Jane or John). For example, if the viewer provides the selection input on the character John, the processor is configured to playback an outcome video segment linked with the character John.

In an example scenario, the multi-branch interactive video content 800 is similar to an interactive story, such that, plot or consequences change based on choice made by the viewer. The choices are based on the selection input provided on either the one or more interactive area or the one or more additional interactive area. The interactive story starts initially with the intro video segment 802 and based on choice made by the viewer, the outcome video segments are played back such that sequence of the interactive story changes. For example, the interactive story branches out from the outcome video segment 804 (also referred to as the ‘intro video segment 802’) to either the outcome video segment 808 or the outcome video segment 810 based on choice made by the viewer.

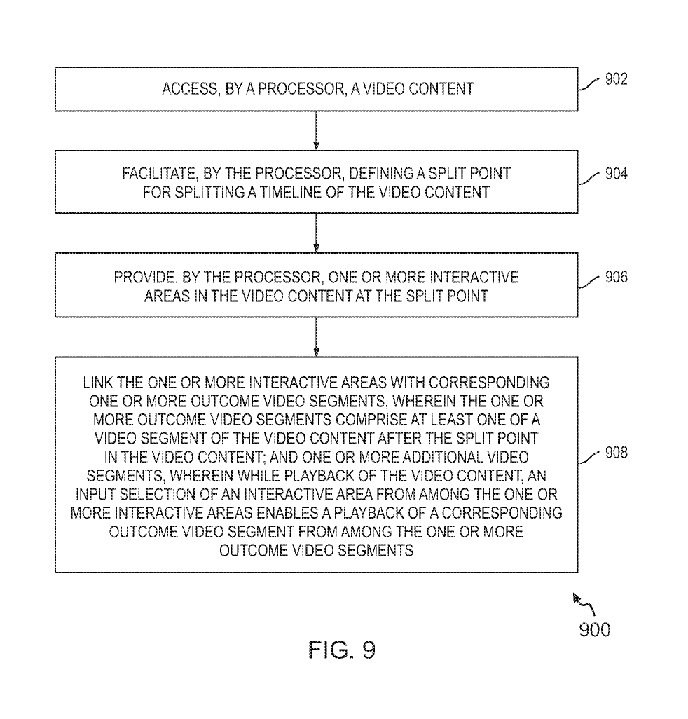

An example of a method for performing playback of a seamless interactive video content is shown and explained with reference to FIG. 9.

Referring now to FIG. 9, a flowchart of a method 900 for creating seamless interactive video content is illustrated, in accordance with an example embodiment. The method 900 includes a sequence of operations that may be carried out by the interactive video application installed at the user device such as the device 104 (shown and explained with reference to FIG. 1). The sequence of operations of the method 900 may not be necessarily executed in the same order as they are presented. Further, one or more operations may be grouped together and performed in form of a single step, or one operation may have several sub-steps that may be performed in parallel or in sequential manner.

At operation 902, the method 900 includes accessing, by a processor, a video content. In one embodiment, the video content is recorded using a camera module of the user device. For example, the video content is recorded via the interactive video application installed on the user device. In another embodiment, the video content may be exported from an existing video library in the user device or an external system for example, an external storage device. At operation 904, the method 900 includes facilitating, by the processor, defining a split point for splitting a timeline of the video content. In at least one example embodiment, the split point is a sliding handle that can be moved in ether directions (left or right) on the timeline of the video content and placed at a point (referred to as ‘the split point’) for segmenting the video content into an intro video content and a video segment. The intro video content is a part of the video content till the split point in the timeline of the video content. The video segment corresponds to video content after the split point in the video content. For example a video content of 2 minute duration on a timeline is split at a split point ‘t’ of 1 minute 10 seconds on the timeline. The video content on the time line before the split point T (1 minute 10 seconds) forms intro video content A and the video segment after the split point ‘t’ (1 minute 10 seconds) constitutes an outcome video segment B. It shall be noted that the video segment after the split point in the video content constitutes an outcome video segment of the one or more outcome video segments. In at least one example embodiment, an idle video loop of a threshold duration is played back when the viewer reaches the split point of the video content. The idle video loop is generated based on a subset of the video content of a threshold length before the split point. For example, some parts of the video content in the intro video segment are selected for the threshold length (e.g., 2 second video segments) and used to generate the idle video loop segment. In one embodiment, the threshold length can be pre-defined and preset in the interactive video application.

At operation 906, the method 900 includes providing, by the processor, one or more interactive areas in the video content at the split point. In at least one example embodiment, at the split point T on the timeline, a viewer is presented with the one or more interactive areas on the video content. For instance, the one or more interactive areas may be embedded on the video content such that the processor may display the one or more interactive areas on the video content at the split point T by a respective colour pattern. For example a first interactive area is represented by a first colour and a second interactive area is represented by a second colour. The one or more interactive areas may be options provided by means of images, representation, text, select regions or a character based choice. In an embodiment, the idle video loop is played back in a forward and backward manner starting from the split point till a time of receiving an input selection of the interactive area. The one or more interactive areas are shown and explained with reference to FIG. 6B.

At operation 908, the method 900 includes linking the one or more interactive areas with corresponding one or more outcome video segments. For instance, each interactive area defined on the video content is associated with an outcome video segment. In an example scenario, the one or more interactive areas may be depicted as characters Mary, Jane and John. The character Mary (first interactive area) may be associated with an outcome video segment V1, Jane (second interactive area) associated with an outcome video segment V2 and John (third interactive area) is associated with an outcome video segment V3.

The one or more outcome video segments include at least one of a video segment of the video content after the split point in the video content and one or more additional video segments. In at least one example embodiment, the one or more additional video segments are recorded using a ghost frame feature. The ghost frame is a semi-transparent image frame corresponding to at least one image frame from the video content before the split point. The ghost frame is overlaid on an image frame viewed via a camera module of the user device for aligning the ghost frame associated with one or more objects in the video content with one or more objects viewed via the camera module for recording an additional video segment that seamlessly transitions from the intro video segment. Alternatively, the one or more additional video segments can be imported from an external system. In an embodiment, the idle video loop is played back to facilitate a seamless transition between a video playback at the split point and a video playback of an outcome video segment of the one or more outcome video segments.

In an embodiment, during playback of the video content, an input selection of an interactive area from among the one or more interactive areas enables a playback of a corresponding outcome video segment from among the one or more outcome video segments. In an example, at the split point ‘t’, the viewer is presented with characters Mary, Jane and John on the video content as the idle video loop plays back simultaneously. If the viewer provides the selection input on the character Jane, then the outcome video segment V2 is played back to the viewer upon receipt of the selection input.

Referring now to FIG. 10, a simplified block diagram of a user device for example a mobile phone 1000 capable of implementing the various embodiments of the present disclosure is illustrated, in accordance with an example embodiment. The user device 1000 may be an example of the device 104. In an embodiment, the various operations related to creating interactive video content can be facilitated using an interactive video application 1006 (standalone application) installed in the mobile phone 1000.

It should be understood that the mobile phone 1000 as illustrated and hereinafter described is merely illustrative of one type of device and should not be taken to limit the scope of the embodiments. As such, it should be appreciated that at least some of the components described below in connection with that the mobile phone 1000 may be optional and thus in an example embodiment may include more, less or different components than those described in connection with the example embodiment of the FIG. 10. As such, among other examples, the mobile phone 1000 could be any of a mobile electronic device or may be embodied in any of the electronic devices, for example, cellular phones, tablet computers, laptops, mobile computers, personal digital assistants (PDAs), mobile televisions, mobile digital assistants, or any combination of the aforementioned, and other types of communication or multimedia devices.

The illustrated mobile phone 1000 includes a controller or a processor 1002 (e.g., a signal processor, microprocessor, ASIC, or other control and processing logic circuitry) for performing such tasks as signal coding, data processing, image processing, input/output processing, power control, and/or other functions. An operating system 1004 control the allocation and usage of the components of the mobile phone 1000 and support for one or more applications programs (see, the interactive video application 1006). The interactive video application 1006 may include common mobile computing applications (e.g., web browsers, messaging applications) or any other computing application. The mobile phone 1000 of the processor 1002 further includes an interactive video creation system (not shown in the FIG. 10) comprising various modules for creating an interactive video content.

The illustrated mobile phone 1000 includes one or more memory components, for example, a non-removable memory 1008 and/or a removable memory 1010. The non-removable memory 1008 and/or the removable memory 1010 may be collectively known as database in an embodiment. The non-removable memory 1008 can include RAM, ROM, flash memory, a hard disk, or other well-known memory storage technologies. The removable memory 1010 can include flash memory, smart cards, or a Subscriber Identity Module (SIM). The one or more memory components can be used for storing data and/or code for running the operating system 1004 and the interactive video application 1006. The mobile phone 1000 may further include a user identity module (UIM) 1012. The UIM 1012 may be a memory device having a processor built in. The UIM 1012 may include, for example, a subscriber identity module (SIM), a universal integrated circuit card (UICC), a universal subscriber identity module (USIM), a removable user identity module (R-UIM), or any other smart card. The UIM 1012 typically stores information elements related to a mobile subscriber. The UIM 1012 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The mobile phone 1000 can support one or more input devices 1020 and one or more output devices 1030. Examples of the input devices 1020 may include, but are not limited to, a touch screen/a display screen 1022 (e.g., capable of capturing finger tap inputs, finger gesture inputs, multi-finger tap inputs, multi-finger gesture inputs, or keystroke inputs from a virtual keyboard or keypad), a microphone 1024 (e.g., capable of capturing voice input), a camera module 1026 (e.g., capable of capturing still picture images and/or video images) and a physical keyboard 1028. Examples of the output devices 1030 may include, but are not limited to a speaker 1032 and a display 1034. Other possible output devices can include piezoelectric or other haptic output devices. Some devices can serve more than one input/output function. For example, the touch screen 1022 and the display 1034 can be combined into a single input/output device.

A wireless modem 1040 can be coupled to one or more antennas (not shown in the FIG. 10) and can support two-way communications between the processor 1002 and external devices, as is well understood in the art. The wireless modem 1040 is shown generically and can include, for example, a cellular modem 1042 for communicating at long range with the mobile communication network, a Wi-Fi compatible modem 1044 for communicating at short range with an external Bluetooth-equipped device or a local wireless data network or router, and/or a Bluetooth-compatible modem 1046. The wireless modem 1040 is typically configured for communication with one or more cellular networks, such as a GSM network for data and voice communications within a single cellular network, between cellular networks, or between the mobile phone 1000 and a public switched telephone network (PSTN).

The mobile phone 1000 can further include one or more input/output ports 1050, a power supply 1052, one or more sensors 1054 for example, an accelerometer, a gyroscope, a compass, or an infrared proximity sensor for detecting the orientation or motion of the mobile phone 1000, a transceiver 1056 (for wirelessly transmitting analog or digital signals) and/or a physical connector 1060, which can be a USB port, IEEE 1294 (FireWire) port, and/or RS-232 port. The illustrated components are not required or all-inclusive, as any of the components shown can be deleted and other components can be added.

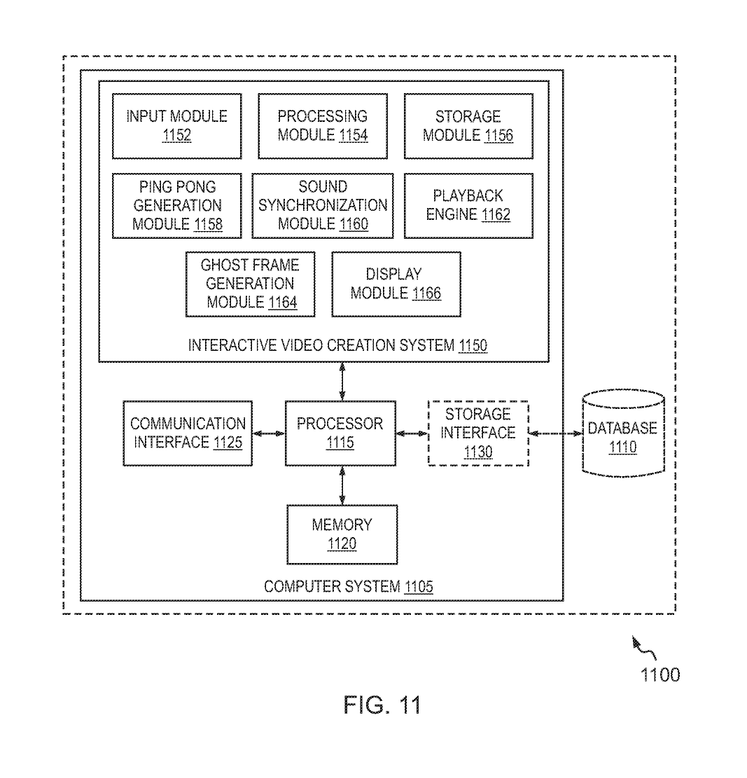

Referring now to FIG. 11, a simplified block diagram of a server 1100, in which the interactive video creation system 200 may be stored is illustrated, in accordance with one embodiment of the present disclosure. The server 1100 includes a computer system 1105 and one or more databases, such as a database 1110.

The computer system 1105 includes a processor 1115 for executing instructions. The processor 1115 may be an example of the processing module 204. Instructions may be stored in, for example, but not limited to, a memory 1120 (example of the storage module 206). The processor 1115 may include one or more processing units (e.g., in a multi-core configuration). The processor 1115 is operatively coupled to a communication interface 1125 such that the computer system 1105 can communicate with a remote device such as the user device 104.

The processor 1115 may also be operatively coupled to the database 1110. The database 1110 is any computer-operated hardware suitable for storing and/or retrieving data. The database 1110 is configured to store the interactive video application capable of creating and sharing seamless interactive video content. The database 1110 may include multiple storage units such as hard disks and/or solid-state disks in a redundant array of inexpensive disks (RAID) configuration. The database 1110 may include, but not limited to, a storage area network (SAN) and/or a network attached storage (NAS) system.

In some embodiments, the database 1110 is integrated within the computer system 1105. For example, the computer system 1105 may include one or more hard disk drives as the database 1110. In other embodiments, the database 1110 is external to the computer system 1105 and may be accessed by the computer system 1105 using a storage interface 1130. The storage interface 1130 is any component capable of providing the processor 1115 with access to the database 1110. The storage interface 1130 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 1115 with access to the database 1110.

The server 1100 is depicted as including an interactive video creation system 1150 comprising various modules for creating an interactive video content. The interactive video creation system 1150 comprises an input module 1152, a processing module 1154, a storage module 1156, a ping pong generation module 1158, a sound synchronization module 1160, a playback engine 1162, a ghost frame generation module 1164 and a display module 1166. It shall be noted that the interactive video creation system 1150 is in operative communication with a processor of the device.

The input module 1152 is configured to receive inputs from one or more devices. The input module 1152 may include at least one input interface. Examples of the input interface may include, but are not limited to, a keyboard, a mouse, a joystick, a keypad, a touch screen, soft keys, a microphone, and the like.

The storage module 1156 is capable of storing machine executable instructions. Further, the processing module 1154 is capable of executing the machine executable instructions. In an embodiment, the processing module 1154 may be embodied as a multi-core processor, a single core processor, or a combination of one or more multi-core processors and one or more single core processors. For example, the processing module 1154 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. The processing module 1154 may be configured to execute hard-coded functionality. The processing module 1154 is embodied as an executor of software instructions, wherein the instructions may specifically configure the processing module 1154 to perform the algorithms and/or operations described herein when the instructions are executed.

The storage module 1156 may be embodied as one or more volatile memory devices, one or more non-volatile memory devices, and/or a combination of one or more volatile memory devices and non-volatile memory devices. For example, the storage module 1156 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.).

The ping pong generation module 1158 is configured to create an automatic idle video loop segment using a ping-pong effect by playing a video segment forward and backward again and again. The ping pong generation module 1158 reverses the whole input video content, and generates a full ping-pong segment by taking parts of the intro video segment from forward video and reverse video and then places the full ping-pong segment between the intro video segment and the outcome video segment. The ping pong generation module 1158 is configured to create a seamless effect to the video content at the end of the intro video segment.

The sound synchronization module 1160 is configured to perform the automatic sound loop synchronization. The sound synchronization module 1160 may play a distinctive sound loop whose tempo is adjusted to match the frequency of the video content. The sound synchronization module 1160 may play the distinctive sound loop while the idle video loop segment is played to synchronize the sound of the intro video segment and the idle video loop segment.

The playback engine 1162 is in communication with the input module 1152 and the display module 1166. In an embodiment, the playback engine 1162 is configured to facilitate playing of the outcome video segment based on a selection made by a viewer (e.g., the viewers 106, 110) on the interactive area of the intro video segment as each interactive area is linked with a particular outcome video segment.

The ghost frame generation module 1164 is in communication with the input module 1152. The ghost frame generation module 1164 is configured to add a ghost frame feature while recording the outcome video segment when the user 102 has opted for the ghost frame feature. The ghost frame generation module 1164 triggers a ghost frame which is a translucent frame taken from the intro video segment, such that the user 102 can alter and adjust position of his/her camera module in the device 104 to match the outcome video segment to be as similar as possible to the intro video segment while recording the outcome video segment.

The display module 1166 is configured to display outputs to one or more devices, such as the devices 104, 108, 112. The display module 1166 includes an output interface. Examples of the output interface may include, but are not limited to, a display such as a light emitting diode display, a thin-film transistor (TFT) display, a liquid crystal display, an active-matrix organic light-emitting diode (AMOLED) display, a microphone, and the like. In an embodiment, the display module 216 is configured to display interactive video contents to the viewers. The display module 216 is configured to display the intro video segment, the idle video loop segment and the outcome video segment based on the interactive area selected by the viewer.

The disclosed methods with reference to FIGS. 1 to 11, or one or more operations of the flow diagram 900 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and Fare considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Various example embodiments disclosed herein advantageously provide methods for creating seamless interactive videos on mobile devices or a server via an interactive video application. The interactive video application comprises a user-friendly user interface for creating interactive video content such that the user can create interactive story branches. The interactive story branches are adapted to change based on choices made by a viewer. The interactive video application provisions for recording video content and importing video content from external devices to create the interactive video content. Additionally, ghost frame feature for recording outcome video segments provided by the interactive video application ensures that the user can record video segments such that there is a seamless transition from the intro video segment to outcome video segments. Further, the interactive video application supports different types of interactions for triggering playback of the outcome video such as tap, slide, tilt, voice commands, and the like. Moreover, the interactive video application provisions for linking multiple video contents to create multi-branch video stories.

Although the invention has been described with reference to specific exemplary embodiments, it is noted that various modifications and changes may be made to these embodiments without departing from the broad spirit and scope of the invention. For example, the various operations, blocks, etc. described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

The present disclosure is described above with reference to block diagrams and flowchart illustrations of method and system embodying the present disclosure. It will be understood that various block of the block diagram and flowchart illustrations, and combinations of blocks in the block diagrams and flowchart illustrations, respectively, may be implemented by a set of computer program instructions. These set of instructions may be loaded onto a general-purpose computer, special purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application \or implementation without departing from the spirit or scope of the claims.

What is claimed is:

1. A method for creating interactive video content, comprising:
accessing, by a processor, a video content;
facilitating, by the processor, defining a split point for splitting a timeline of the video content;
providing, by the processor, one or more interactive areas in the video content at the split point; and
linking, by the processor, the one or more interactive areas with corresponding one or more outcome video segments, wherein the one or more outcome video segments comprise at least one of:
a video segment of the video content after the split point in the video content; and
one or more additional video segments;
wherein while playback of the video content, an input selection of an interactive area from among the one or more interactive areas enables a playback of a corresponding outcome video segment from among the one or more outcome video segments.

2. The method as claimed in claim 1, further comprising generating an idle video loop of a threshold duration at the split point for a transition between a video playback at the split point and a video playback of an outcome video segment of the one or more outcome video segments.

3. The method as claimed in claim 2, wherein the idle video loop is generated based on a subset of the video content of a threshold length before the split point.

4. The method as claimed in claim 2, further comprising performing a playback of the video content by playing back the idle video loop in a forward and backward manner starting from the split point till a time of the input selection of the interactive area.

5. The method as claimed in claim 2, wherein performing the playback comprises playing back a sound loop with the playback of the idle video loop.

6. The method as claimed in claim 2, wherein linking the one or more interactive areas comprises accessing the one or more additional video segments by at least one of:
recording the one or more additional video segments by overlaying a ghost frame on an image frame displayed on the display screen for aligning one or more objects in the video content prior to the split point with one or more objects displayed on the display screen, the ghost frame comprising a semi-transparent frame from the video content before the split point; and
importing the one or more additional video segments from an external system.

7. The method as claimed in claim 2, further comprising facilitating, by the processor, an option in a user device for storing an interactive video content comprising an intro video content, the idle video loop, and the one or more outcome video segments, wherein the intro video content is a part of the video content till the split point in the timeline of the video content.

8. The method as claimed in claim 1, further comprising providing, by the processor, an option for publishing the video content.

9. The method as claimed in claim 1, further comprising displaying the one or more interactive areas on the video content by a respective colour pattern.

10. The method as claimed in claim 7, further comprising:
defining one or more additional interactive areas on each of the one or more outcome video segments; and
linking one or more additional outcome video segments with the one or more additional interactive areas, in respective manner.

11. The method as claimed in claim 1, further comprising performing playback of the video content by presenting the one or more interactive areas at the split point of the video content.

12. A system for creating seamless interactive video content, the system comprising:
a memory configured to store instructions; and
a processor configured to execute the instructions stored in the memory and thereby cause the system to perform:
accessing of a video content;
facilitating defining a split point for splitting a timeline of the video content;
providing one or more interactive areas in the video content at the split point; and
linking the one or more interactive areas with corresponding one or more outcome video segments, wherein the one or more outcome video segments comprise at least one of:
a video segment of the video content after the split point in the video content; and
one or more additional video segments;
wherein while playback of the video content, an input selection of an interactive area from among the one or more interactive areas enables a playback of a corresponding outcome video segment from among the one or more outcome video segments.

13. The system as claimed in claim 11, wherein the system is further caused to perform:
generating an idle video loop of a threshold duration at the split point for a transition between a video playback at the split point and a video playback of an outcome video segment of the one or more outcome video segments.

14. The system as claimed in claim 13, wherein the idle video loop is generated based on a subset of the video content of a threshold length before the split point.

15. The system as claimed in claim 13, wherein the system is further caused to perform a playback of the video content by playing back the idle video loop in a forward and backward manner starting from the split point till a time of the input selection of the interactive area.

16. The system as claimed in claim 13, wherein for linking the one or more interactive areas the system is further configured to access the one or more additional video segments by at least one of:
recording the one or more additional video segments by overlaying a ghost frame on an image frame displayed on the display screen for aligning one or more objects in the video content prior to the split point with one or more objects displayed on the display screen, the ghost frame comprising a semi-transparent frame from the video content before the split point; and
importing the one or more additional video segments from an external system.

17. The system as claimed in claim 16, wherein the system is further configured to facilitate an option in a user device for storing an interactive video content comprising an intro video content, the idle video loop, and the one or more outcome video segments, wherein the intro video content is a part of the video content till the split point in the timeline of the video content.

18. A system, comprising:
an input module for accessing a video content;
one or more processing modules configured to
facilitate defining a split point for splitting a timeline of the video content;
provide one or more interactive areas in the video content at the split point; and
link the one or more interactive areas with corresponding one or more outcome video segments, wherein the one or more outcome video segments comprise at least one of:
a video segment of the video content after the split point in the video content; and
one or more additional video segments;
a ping pong generation module for generating an idle video loop of a threshold duration at the split point for a transition between a video playback at the split point and a video playback of an outcome video segment of the one or more outcome video segments, the idle video loop being generated based on a subset of the video content of a threshold length before the split point;
a sound synchronization module for performing a play back of a sound loop with the playback of the idle video loop, the idle video loop being played back in a forward and backward manner starting from the split point till a time of the input selection of the interactive area;
a playback engine for performing a playback of the video content, an input selection of an interactive area from among the one or more interactive areas enables a playback of a corresponding outcome video segment from among the one or more outcome video segments; and
a display module for displaying the playback of an interactive video content, the interactive video content comprising an intro video content, the idle video loop, and the one or more outcome video segments, wherein the intro video segment is a part of the video content till the split point in the timeline of the video content.

19. The system as claimed in claim 18, further comprising:
a ghost frame generation module for generating a ghost frame from the video content before the split point, the ghost frame comprising a semi-transparent image frame facilitates recording of the one or more additional video segments by overlaying the ghost frame on an image frame displayed on the display screen for aligning one or more objects in the ghost frame with one or more objects viewed via a camera module.

20. The system as claimed in claim 19, further comprising:
a storage module to store an interactive video content comprising an intro video content, the idle video loop, and the one or more outcome video segments.
